(19) United States
(12) Patent Application Publication
(10) Pub. No.: US 2025/0181904 A1
(43) Pub. Date: Jun. 5, 2025

(54) USING A PROPERTY OF ELECTROMAGNETIC RADIATION PERFORMING COLLECTIVE OPERATIONS ASSOCIATED WITH AN ARTIFICIAL INTELLIGENCE MODEL

(71) Applicant: Microsoft Technology Licensing, LLC, Redmond, WA (US)

(72) Inventors: Teresa Ann NICK, Towson, MD (US); Winston Allen SAUNDERS, Seattle, WA (US); Maria Leena Kyllikki VIITANIEMI, Seattle, WA (US)

(21) Appl. No.: 18/526,186

(22) Filed: Dec. 1, 2023

(51) Int. Cl. G06N 3/063; G06N 3/08

(52) U.S. Cl. CPC G06N 3/063; G06N 3/08

(57) ABSTRACT

Systems and methods for performing collective operations associated with artificial intelligence (AI) using a property of electromagnetic radiation are described. An example method for processing an artificial intelligence (AI) model includes a first set of neurons associated with a first layer of the AI model communicating via electromagnetic radiation: (1) reference signals for facilitating a collective operation associated with the AI model, and (2) input signals for use with a second layer of the AI model for performing the collective operation associated with the AI model. The method further includes a second set of neurons associated with the second layer receiving, as a result of processing of a property of the electromagnetic radiation, the reference signals, and the input signals for performing the collective operation associated with the AI model.

### BACKGROUND

Artificial intelligence is used to perform complex tasks such as reading comprehension, language translation, image recognition, or speech recognition. Artificial intelligence systems, such as those based on Natural Language Processing (NLP), Recurrent Neural Networks (RNNs), Convolutional Neural Networks (CNNs), Long Short Term Memory (LSTM) neural networks, or Gated Recurrent Units (GRUs) have been deployed to perform such complex tasks. In many such systems, model parallelism is used to accelerate operations associated with the model. Model parallelism requires splitting the model across several processing units (e.g., GPUs). The splitting of the model requires all-to-all communication among the model portions (e.g., neurons or layers). Communication latencies among the processing units can degrade the performance of artificial intelligence systems during both inference and training. In addition, the energy cost and the memory load during communication in large clusters is greater than that during computation.

Accordingly, there is a need for systems and methods that reduce communication data volumes and latencies while performing collective operations.

### SUMMARY

In one example, the present disclosure relates to a method for processing an artificial intelligence (AI) model. The method may include a first set of neurons associated with a first layer of the AI model communicating via electromagnetic radiation: (1) reference signals for facilitating a collective operation associated with the AI model, and (2) input signals for use with a second layer of the AI model for performing the collective operation associated with the AI model. The method may further include a second set of neurons associated with the second layer receiving, as a result of processing of a property of the electromagnetic radiation, the reference signals, and the input signals for performing the collective operation associated with the AI model.

In another example, the present disclosure relates to a method for processing an artificial intelligence (AI) model comprising L layers, where L is an integer greater than or equal to 2. The method may include using associated projectors, a first set of the processing units: (1) projecting electromagnetic radiation on a surface corresponding to reference signals for facilitating a collective operation associated with two of the L layers of the AI model, and (2) projecting electromagnetic radiation on the surface corresponding to any population sum signals for use with the collective operation associated with the two of the L layers of the AI model. The method may further include using at least one electromagnetic radiation sensor pointed at the surface, a second set of processing units acquiring the reference signals, and any population sum signals for use with the collective operation associated with the two of the layers of the AI model.

In a yet another example, the present disclosure relates to a system for processing an artificial intelligence (AI) model. The system may include a first sub-system to enable a first set of neurons associated with a first layer of the AI model to communicate via electromagnetic radiation: (1) reference signals for facilitating a collective operation associated with the AI model, and (2) input signals for use with a second layer of the AI model for performing the collective operation associated with the AI model. The system may further include a second sub-system to enable a second set of neurons associated with the second layer to receive, as a result of processing of a property of the electromagnetic radiation, the reference signals, and the input signals for performing the collective operation associated with the AI model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is an example system environment for performing collective operations associated with artificial intelligence (AI) using a property of electromagnetic radiation;

FIG. 2 shows an example set of signals that are communicated using electromagnetic radiation to perform collective operations associated with artificial intelligence;

FIG. 3 shows a binary encoding and a summation technique for improving the dynamic range of values used as part of the collective operation;

FIG. 4 shows example processing of information communicated, for performing a collective operation, via electromagnetic radiation by an image sensor on a pixel-by-pixel basis;

FIG. 5 shows a system for processing an artificial intelligence (AI) model in accordance with one example;

FIG. 6 shows another example system for performing a collective operation as part of the system environment of FIG. 1;

FIG. 7 shows another example system for performing a collective operation as part of the system environment of FIG. 1;

FIG. 8 shows a flow chart of a method for processing an AI model in accordance with one example; and

FIG. 9 shows a flow chart of a method for processing an AI model comprising L layers in accordance with one example.

### DETAILED DESCRIPTION

Examples disclosed in the present example relate to performing collective operations associated with an artificial intelligence (AI) model using a property of electromagnetic radiation. Artificial intelligence is used to perform complex tasks such as reading comprehension, language translation, image recognition, or speech recognition. Artificial intelligence systems, such as those based on Natural Language Processing (NLP), Recurrent Neural Networks (RNNs), Convolutional Neural Networks (CNNs), Long Short Term Memory (LSTM) neural networks, or Gated Recurrent Units (GRUs) have been deployed to perform such complex tasks. Certain examples relate to artificial intelligence systems in which the layers, sublayers, or even smaller portions of the AI model are partitioned to achieve model parallelism. As an example, in model parallelism, different processing units in the system may be responsible for the computations in different parts of a single network—for example, each layer, sublayer, or even a smaller portion of the neural network may be assigned to a different processing unit in the system. Thus, as part of model parallelism, the neural network model may be split among different processing units (e.g., CPUs, GPUs, IPUs, FPGAs, or other types of such units) but each processing unit may use the same data. The splitting of the model requires all-to-all communication among the model portions (e.g., the neurons associated with the various neural network layers). Communication latencies and data volumes among the processing units can degrade the performance of artificial intelligence systems during both inference and training.

Certain examples in this disclosure further relate to communicating among processing units using electromagnetic radiation to perform collective operations associated with an artificial intelligence (AI) model. Collective operations include operations that allow collection of data from different processing units (e.g., GPUs) associated with one portion of the AI system to combine them into a result for another portion of the AI system. As an example, during inference a layer of an AI model provides results of the computation by neurons in that layer to the neurons for the next layer. This means that all of the computations from a layer (e.g., layer L-1) would have to be supplied to each processing unit that would perform the next layer's (layer L) computations. As used herein the term “neuron” refers to a connection point in an artificial intelligence system having layers for processing inputs and providing outputs, where the connection point has the capability to receive an input and provide an output to other connection points in the AI system.

Similarly, during training as part of backpropagation, model parameters are synchronized by exchanging updated gradients. Parameter updates are applied during backpropagation. Thus, during training as part of a backward pass a layer of an AI model provides results of the computation by neurons in that layer to the neurons for the previous layer. As an example, the gradient of a loss function with respect to the weights in the network (or a portion of the network) is calculated. The gradient is then fed to an optimization method that uses the gradient to update the weights to minimize the loss function. The goal with backpropagation is to update each of the weights (or at least some of the weights) in the network so that they cause the actual output to be closer to the target output, thereby minimizing the error for each output neuron and the network as a whole.

In one example, using the systems and methods described herein, the summation of activation weights can be processed using the AllReduce collective operation in one step. In some instances, control planes may not be necessary because the processing units can either be pre-programmed to process a defined part of the model (inference) or self-organize and parallelize the model based on the size of their allotted data partition (training). Although transmission bandwidth is currently limited by visible light peripherals, such as displays and cameras, that are optimized for relatively slow human vision, this limit does not present a technological barrier. Electromagnetic radiation from at least infrared rays to ultraviolet rays, including visible light, may be used with the systems and methods described herein. In terms of wavelength, the electromagnetic radiation may range from nanometers (e.g., 400 nanometers) to a few microns (e.g., 1.6 microns). The specific range of wavelength that is used will depend on the type of projectors, cameras, fiber optics, lasers, or other such equipment being used for the communication of the electromagnetic radiation. As an example, radiofrequency waves in a range of 3 kHz to 300 MHz may be used. As another example, microwaves in a range of 300 MHz to 300 GHz may also be used. Depending on the frequency, and thus the wavelength, of the electromagnetic radiation being used, the equipment used for communicating such signals may be tailored.

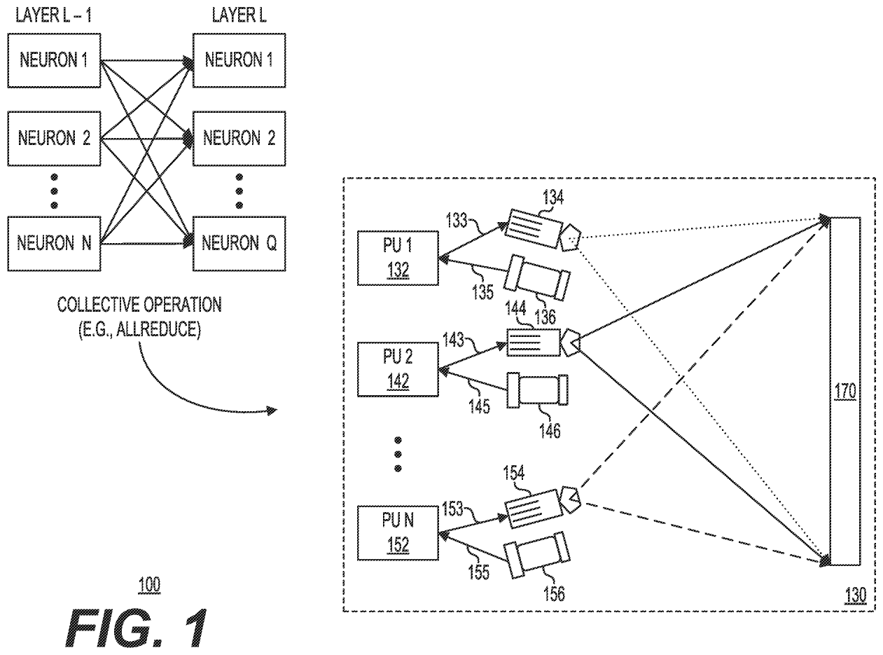

FIG. 1 is an example system environment 100 for performing collective operations associated with artificial intelligence (AI) using a property of electromagnetic radiation. System environment 100 relates to an artificial intelligence system that once trained can be used for predicting outputs as part of inference. System environment 100 shows the model as including layers L−1 and L, where layer L−1 includes several neurons (neuron 1, neuron 2, and neuron N) and layer L includes several neurons (neuron 1, neuron 2, and neuron Q). For neuron 1 in layer L, the activation is equal to an activation function (Ø) on the sum of all weighted inputs (aw) to neuron 1 with some bias b: a₁^{(l)}=Ø(a₀^{(l=1)}w_{0,1}^{(l)}+a₁^{(l-1)}w_{1,1}^{(l)}+ . . . +aₘ^{(l-1)}w_{m,1}^{(l)}+b^{(l)}). The inputs (e.g., a₀^{(l-1)}, a₁^{(l-1)}, and aₘ^{(l-1)} in this example are the set of values for which one needs to predict an output value. These can be viewed as features or attributes included in the data. The weights (e.g., w_{0,1}^{(l)}, w_{1,1}^{(l)}, and w_{m,1}^{(l)} are values that are attached to each input to convey the importance of the corresponding input or feature in predicting the final output. The bias (e.g., b (t)) can be used to shift the activation function towards left or right. The weights and the bias are parameters that have been learned during training of the AI model.

The activation function (e.g., Ø) is used to introduce non-linearity in the model and the summation function is used to bind the weights and inputs together. Examples of activation functions include rectified linear unit (ReLU) activation function, leaky ReLU, parametric ReLU, Gaussian-error linear unit (GELU) activation function, and other variants of ReLU. Moreover, aside from ReLU any other appropriate non-linear or linear activation functions may be used. In this example, in order to calculate the summation (a₁^{(l)}, one needs information across all of layer L−1, even if the neurons in layer L−1 are partitioned across processing units as part of model parallelism. This means that in this example all of the layer L−1 activations would have to be supplied to each processing unit that would calculate layers L's a₁^{(l)} to a_{q}^{(l)}.

With continued reference to FIG. 1, system environment 100 shows system 130, which is one example implementation for performing the collective operation as part of the AI system. System 130 includes several processing units (e.g. processing units PU 1 132, PU 2 142, and PU N 152). Each of the processing units can be a graphics processing unit (GPU). As explained earlier, the processing units can be implemented using other hardware options, as well. As an example, a processing unit may be implemented as one or more computer processing units (CPUs), field programmable gate arrays (FPGAs), application specific integrated circuits (ASICs), erasable and/or complex programmable logic devices (PLDs), programmable array logic (PAL) devices, or generic array logic (GAL) devices. In this example, each of the processing units is further coupled to a projector and a camera. As an example, PU 1 132 is coupled via link 133 to projector 134 and is also coupled via link 135 to camera 136. PU 2 142 is coupled via link 143 to projector 144 and is also coupled via link 145 to camera 146. PU N 152 is coupled via link 153 to projector 154 and is also coupled via link 155 to camera 156. Each of links 133, 143, and 153 may be implemented as a display port link. Other high-speed links for connecting processing units to projectors may also be used. Each of links 135, 145, and 155 may be implemented as a peripherals component express (PCIe) link. Oher high-speed links for connecting processing units to cameras may also be used. Each projector is configured to project information communicated via electromagnetic radiation onto the surface of a screen 170. Other configurations that aggregate part of the data before projection are possible, depending on the model size and design. For example, all of the processing units in one server or one rack could share a projector and a camera.

Still referring to FIG. 1, each processing unit is configured to process one or more neurons associated with a layer. As an example, assuming there are 256 neurons in layer L, PU 1 132 may be configured to process a subset of the 256 neurons, PU 2 142 may be configured to process the next subset of the 256 neurons, and finally PU N 152 may be configured to process the last subset of the 256 neurons. Partitioning may be performed using code configured to partition the model based on machine language frameworks, such as Tensorflow, Apache MXNet, and Microsoft® Cognitive Toolkit (CNTK). Thus, the various layers of the model may be assigned for processing using different processing units. This way the various parameters associated with layers may be processed in parallel.

In one example, the neural network model may comprise of many layers and each layer may be encoded as matrices or vectors of weights expressed in the form of coefficients or constants that have been obtained via training of a neural network. Taking the LSTM example, an LSTM network may comprise a sequence of repeating RNN layers or other types of layers. Each layer of the LSTM network may consume an input at a given time step, e.g., a layer's state from a previous time step, and may produce a new set of outputs or states. In the case of using the LSTM, a single chunk of content may be encoded into a single vector or multiple vectors. As an example, a word or a combination of words (e.g., a phrase, a sentence, or a paragraph) may be encoded as a single vector. Each chunk may be encoded into an individual layer (e.g., a particular time step) of an LSTM network. An LSTM layer may be described using a set of equations, such as the ones below:

$${i}_{t} = σ ( {W}_{xi} xt + {W}_{hi} {h}_{t - 1} + {W}_{ci} {c}_{t - 1} + {b}_{i} )$$

$${f}_{t} = σ ( {W}_{xf} {x}_{t} + {W}_{hf} {h}_{t - 1} + {W}_{cf} {c}_{t - 1} + {b}_{f} )$$

$${c}_{t} = {f}_{t} {c}_{t - 1} {i}_{t} tanh ( {W}_{xc} {x}_{t} + {W}_{hc} {h}_{t - 1} + {b}_{c} )$$

$${o}_{t} = σ ( {W}_{xo} {x}_{t} + {W}_{ho} {h}_{t - 1} + {W}_{co} {c}_{t} + {b}_{o} )$$

$${h}_{t} = {o}_{t} tanh ( {c}_{t} )$$

In this example, inside each LSTM layer the inputs and hidden states may be processed using a combination of vector operations (e.g., dot-product, inner product, or vector addition) and non-linear functions. In certain cases, the most compute intensive operations may arise from the dot products, which may be implemented using dense matrix-vector and matrix-matrix multiplication routines. Although FIG. 1 shows system 130 as including certain components that are arranged in a certain manner, system 130 may include additional or fewer components arranged differently. As an example, screen 170 could be a wall or a sensor array.

System 130 and the associated models can be deployed in cloud computing environments. Cloud computing may refer to a way for enabling on-demand network access to a shared pool of configurable processing units. For example, cloud computing can be employed in the marketplace to offer ubiquitous and convenient on-demand access to the shared pool of configurable processing units. The shared pool of configurable processing units can be rapidly provisioned via virtualization and released with low management effort or service provider interaction, and then scaled accordingly. A cloud computing model can be composed of various characteristics such as, for example, on-demand self-service, broad network access, resource pooling, rapid elasticity, measured service, and so forth. A cloud computing model may be used to expose various service models, such as, for example, Hardware as a Service (“HaaS”), Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth.

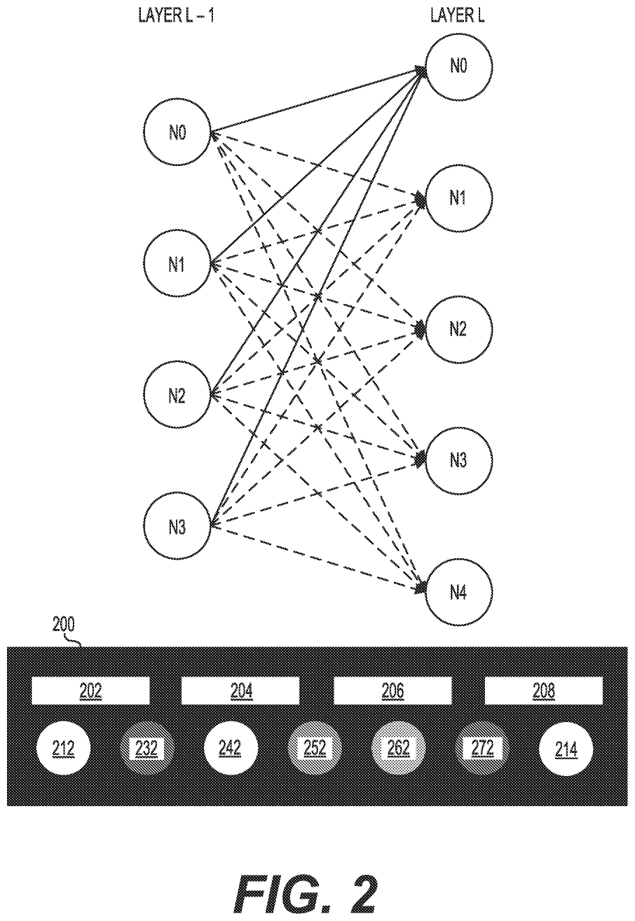

FIG. 2 shows an example set of signals 200 that are communicated using electromagnetic radiation to perform collective operations associated with artificial intelligence. To explain the signals 200, four neurons N0, N1, N2, and N3 are shown for layer L−1 and five neurons N0, N1, N2, N3, and N4 are shown for layer L. This example relates to inference and shows the use of the electromagnetic radiation's use in the context of signals being communicated from each of the four N0, N1, N2, and N3 of layer L−1 to neurons of layer L. Accordingly, the weights (w) and bias (b) are known and can simply be stored local to the processing unit corresponding to the neurons. Thus, in this example, only the new input data to be processed by the neurons in layer L needs to be sent from each of the neurons of layer L−1 to neuron NO of layer L. Neuron NO of layer L needs to compute a₁^{(l)}=Øa₀^{(l-1)}w_{0,1}^{(l)}+a₁^{(l-1)}w_{1,1}^{(l)}+a₂^{(l-)}w_{2,1}^{(l)}+a₃^{(l-1)}w_{3,1}^{(l)}+_{b}^{(l)}). To enable this computation, neuron NO of layer L−1 needs to send the value of a₀^{(l-1)}w_{0,1}^{(l)} to neuron NO of layer L. Neuron N1 of layer L−1 needs to send the value of a₁^{(l-1)}w_{1,1}^{(l)} to neuron NO of layer L. Neuron N2 of layer L−1 needs to send the value of a₂^{(l-1)}w_{2,1}^{(l)} to neuron NO of layer L. Neuron N3 of layer L−1 needs to send the value of a₃^{(l-1)}w_{3,1}^{(l)} to neuron NO of layer L. Neuron NO to neuron N5 of layer L need to communicate the activation sum signals to the next layer of the model.

With continued reference to FIG. 2, in this example, the luminous intensity of the electromagnetic radiation (e.g., the luminous intensity of visible light) is used to communicate data from each of the neurons (N0, N1, N2, and N3 of layer L−1) to the neurons associated with the next layer (layer L). Screen 200 shows projected light shapes to illustrate example signals communicated by a processing unit (e.g., any of the processing units described earlier with respect to FIG. 1). In this example, three types of signals are shown projected on screen 200. These include individual references signals 202, 204, 206, and 208, population reference signals 212 and 214, and population sum signals 232, 242, 252, 262, and 272. The location and shape of each signal on screen 200 provides additional information, including as an example, the source of the signal and/or the purpose of the signal. Some of these signals facilitate communication among processing units and others communicate actual data used by the next layer for computation. The reference signals can be viewed as metadata or header information. As an example, each individual reference signal (e.g., 202) indicates whether a particular layer L−1 neuron has voted. Thus, the projected light on screen 200 in the left most and top-most location indicates that neuron NO of layer L−1 has voted. Individual reference signals 202, 204, 206, and 208 may also enable population tracking of missing tensor slices and processing units, as well. Moreover, such signals may allow normalization of the signals across the processing units (e.g., GPUs). In other examples, the individual reference signals 202, 204, 206, and 208 may be used for various ways to facilitate communication and calibration of system 130 of FIG. 1. As another example, CPU-based applications can use “efference copy” feedback to adjust luminance and align projections across the processing units during the setting up of system 130 of FIG. 1. As an example, during communication of the electromagnetic radiation (e.g., via a projector) a sender can simultaneously transmit and check what is being sent, and then adjust based on the feedback. Thus, if the sender is expecting to project a piece of data, but somehow the shared screen becomes obstructed, the sender will not see the data on the screen that it expected to see. Based on this “efference copy” feedback, the sender can project the data onto another spot on the screen until the feedback confirms that what is being sent is indeed being projected at the right spot on the screen.

A population reference signal (e.g., 212) is a result of electromagnetic radiation (e.g., visible light) being projected by those neurons that are participating in the collective operation. The maximum luminous intensity associated with the population reference signal indicates that all of the neurons from a layer (e.g., layer L−1) are participating as part of the collective operation. The population reference signals 212 and 214 can also be used for calibration of the property of the electromagnetic radiation across the processing units. In addition, the population reference signals 212 and 214 can also be used for the alignment of the projected information with the cameras. The population reference signals 212 and 214 may also be used to monitor signal drift through the amplitude of a population of neurons, which may also be viewed as the population of the tensor slices, that are participating in a collective operation being performed as part of system 130 of FIG. 1. The population reference signals 212 and 214 may also be used to track the population of the processing units that are participating in a collective operation being performed as part of system 130 of FIG. 1. Screen 200 shows redundant population reference signals. Thus, both population reference signals 212 and 214 are communicating the same information in a redundant manner. There are several situations in which the population reference signals 212 and 214 and the individual reference signals 202, 204, 206, and 208 can be useful during system setup and management. As an example, there may be a situation where a processing unit has a system fault or has a lot more data to process than it can handle, and thus that processing unit may be unable to participate in the collective operation. Thus, the use of these signals is a way of telling the receiving layer everybody has checked in. The individual reference signals can also be helpful in determining if there is a projector that has a faulty bulb or has another type of fault. If one of the individual reference signals (e.g., any of 202, 204, 206, and 208) is darker than the others and if each one of them is calibrated to have the same luminous intensity, then it indicates that there is a problem in the system that needs to be addressed before using the system.

Still referring to FIG. 2, the population sum signals 232, 242, 252, 262, and 272 provide information for use with the neurons in the next layer. Each of the neurons associated with layer L−1 projects electromagnetic radiation (e.g., visible light), whose intensity is proportional to that neuronal connection's weighted activation, at a specific spot associated with screen 200. As an example, population sum signal 232 is a result of the summation of the weighted activation signals (e.g., a₀^{(l-1)}, w_{0,1}^{(l)}, a₁^{(l-1)}w_{1,1}^{(l)}, a₂^{(l-1)}w_{2,1}^{(l)}, and a₃^{(l-1)}w_{3,1}^{(l)}) received from all four neurons (N0, N1, N2, and N3) of layer L−1 at the specific spot on screen 200 that is associated specifically with population sum signal 232. Population sum signal 242 is a result of the summation of the weighted activation signals (e.g., a₀^{(l-1)}w_{0,2}^{(l)}, a₁^{(l-1)}w_{1,2}^{(l)}, a₂^{(l-1)}w_{2,2}^{(l)}, and a₃^{(l-1)}w_{3,2}^{(l)}) received from all four neurons (N0, N1, N2, and N3) of layer L−1 at another specific spot on screen 200 that is associated specifically with population sum signal 242. Population sum signal 252 is a result of the summation of the weighted activation signals (e.g., a₀^{(l-1)}w_{0,3}^{(l)}, a₁^{(l-1)}w_{1,3}^{(l)}, a₂^{(l-1)}w_{2,3}^{(l)}, and a₃^{(l-1)}w_{3,3}^{(l)}) received from all four neurons (n0, N1, N2, and N3) of layer L−1 at another specific spot on screen 200 that is associated specifically with population sum signal 252. Population sum signal 262 is a result of the summation of the weighted activation signals (e.g., a₀^{(l-1)}w_{0,4}^{(l)}, a₁^{(l-1)}w_{1,4}^{(l)}, a₂^{(l-1)}w_{2,4}^{(l)}, and a₃^{(l-1)}w_{3,4}^{(l)}) received from all four neurons (N0, N1, N2, and N3) of layer L−1 at another specific spot on screen 200 that is associated specifically with population sum signal 262. Finally, population sum signal 272 is a result of the summation of the weighted activation signals (e.g., a₀^{(l-1)}w_{0,5}^{(l)}, a₁^{(l-1)}w_{1,5}^{(l)}, a₂^{(l-1)}w_{2,5}^{(l)}, and a₃^{(l-1)}w_{3,5}^{(l)}) received from all four neurons (N0, N1, N2, and N3) of layer L−1 at another specific spot on screen 200 that is associated specifically with population sum signal 272.

As explained earlier with respect to FIG. 1, a processing unit and its associated projector can project the population sum signals of its input neurons on the specific spots associated with respective target neurons. The spots themselves could be arranged in a matrix form with x and y coordinates associated with each spot. Other ways may also be used to indicate the association between a spot and the signal associated with that spot on screen 200.

With continued reference to FIG. 2, one or more cameras associated with one or more processing units for the neurons of the next layer could pass the luminous intensity to such processing units. The processing unit may then perform the computation: a₁^{(l)}=Ø(a₀^{(l-1)}w_{0,1}^{(l)}, a₁^{(l-1)}w_{1,1}^{(l)}, a₂^{(l-1)}w_{2,1}^{(l)}+a₃^{(l-1)}w_{3,1}^{(l)}+b^{(l)}), where a₀^{(l-1)}w_{0,1}^{(l)}+a₁^{(l-1)}w_{1,1}^{(l)}+a₂^{(l-1)}w_{2,1}^{(l)}+a₃^{(l-1)}w_{3,1}^{(l)} is provided by the summed luminance overlay of the input signals for each neuron. This would result in the completion of the collective operation (e.g., AllReduce) in one step using the electromagnetic radiation (e.g., visible light). Although FIG. 2 shows a certain number and arrangement of neurons for the layers, each layer may include additional or fewer neurons. Moreover, the neurons for different layers can be supported by the same processing unit or different processing units. In addition, although FIG. 2 shows screen 200 with a certain arrangement and type of signals, screen 200 may include additional or fewer signals that are arranged differently. Screen 200 itself may be a wall or any other structure that can be used for sharing of the luminous intensity or other properties associated with the electromagnetic radiation.

In addition, although FIG. 2 shows the movement of data from layer L−1 to L, the movement of data may be in the opposite direction, as well. As noted earlier, during training as part of backpropagation, model parameters are updated by backflow of error gradients. Weight and bias parameter updates are applied during backpropagation. Thus, during training as part of a backward pass a layer of an AI model provides results of the loss or error computation by neurons in that layer to the neurons for the previous layer (e.g., neurons in layer L provides the results to the neurons in layer L−1 of FIG. 2). The gradient of a loss function with respect to the weights and bias in the network (or a portion of the network) is calculated. The gradient is then fed to an optimization method that uses the gradient to update the weights to minimize the loss function. The goal with backpropagation is to update each of the weights (or at least some of the weights) in the network so that they cause the actual output to be closer to the target output, thereby minimizing the error for each output neuron and the network as a whole. As used herein, the term “population sum signal” described earlier refers to gradient of the error in the context of backpropagation while training the AI model. Conversely, in the context of inference the “population sum signal” refers to the population activation sum signal.

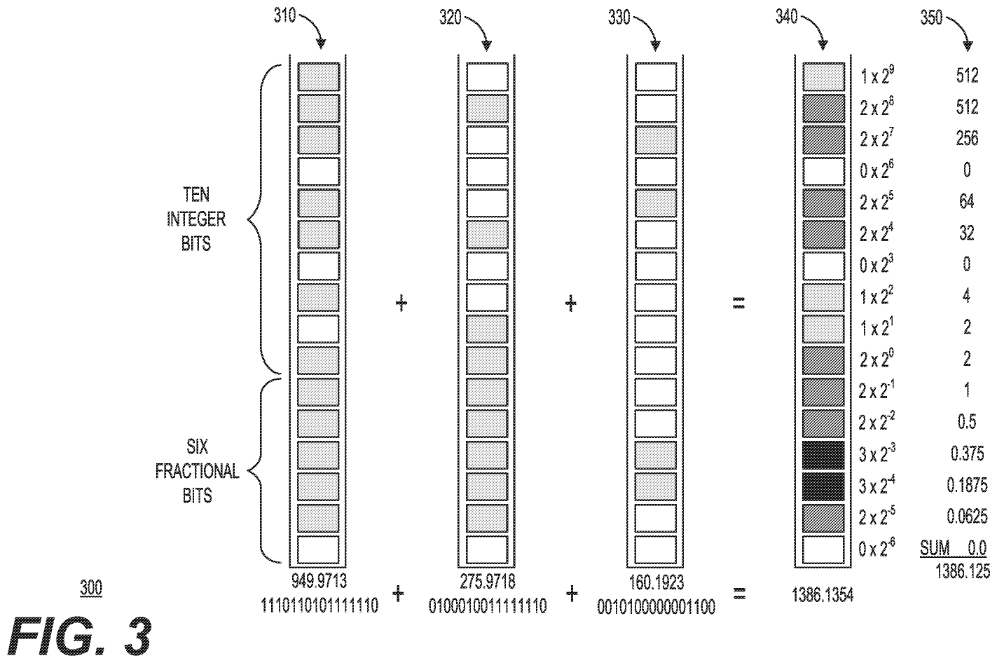

FIG. 3 shows a binary encoding and a summation technique 300 for improving the dynamic range of values used as part of the collective operation. Although floating point representation of values as part of the model processing may have slightly higher accuracy, this comes at the expense of transmission bandwidth. Accuracy and bandwidth can be optimized for each use case. To simplify the processing while maintaining a reasonable dynamic range of the values, fixed point representation of values may be used. In one example, fixed point representation may use a set number of integer bits and fractional bits to express numbers. Fixed point values can be efficiently processed in hardware with integer arithmetic, which may make it a preferred format for use with the systems described herein. Fixed point format may be represented as qX.Y, where X is the number of integer bits and Y is the number of fractional bits. Block-floating point (BFP) may apply a shared exponent to a block of fixed point numbers; for example, a vector or matrix. The shared exponent may allow a significantly higher dynamic range for the block, although individual block members have a fixed range with respect to each other. Quantization involving mapping continuous or high-precision values onto a discrete, low-precision grid, may be used to arrive at the fixed point representations of the floating point values. If the original points are close to their mapped quantization value, then one expects that the resulting computations will be close to the original computations.

With continued reference to FIG. 3, as part of the binary encoding and summation technique 300 the population sum signals (e.g., similar to 232, 242, 252, 262, and 272 of FIG. 2) may be encoded using fixed point integer values. In the example shown in FIG. 3, the fixed point integer values include ten integer bits and six fractional bits. Column 310 corresponds to the population sum signal from one or more neurons of the input layer from one processing unit to one target neuron. Column 320 corresponds to the population sum signal from another processing unit with input neuron(s) to the same target neuron, and column 330 corresponds to the population sum signal from another processing unit with input neuron(s) to the same target neuron. Column 340 shows the bitwise addition of the fixed point integer values of columns 310, 320, and 340, which together comprise the summed weighted activations for one target neuron. Column 310 represents the output of one of the processing units shown in FIG. 1, column 320 represents the output of another one of the processing units shown in FIG. 1, and column 330 represents the output of yet another one of the processing units shown in FIG. 1. Column 350 shows the computation including an error when summing up the binary numbers, which equals the total activations for one target neuron.

As depicted in column 340, the location (e.g., identifiable via a row number and a column number or on a grid associated with a surface) of the signals in the column corresponds to a weight of that location. As an example, the topmost entry in the column for the spaces corresponding to the ten integer bits has the largest weight (2⁹). The next entry below in the column for the spaces corresponding to the ten integer bits has a weight of 2⁸. The weight of each of the next entries below continues to go down until the tenth integer bit in this example, which has a weight of 2⁰. The next entries in column 340 correspond to the six fractional bits. These entries' weights also depend on the location in the column.

As shown by the differences in the intensity of gray shading in column 340, the information for the collective operation is communicated using the electromagnetic radiation. Thus, similar to the signals shown as part of screen 200 of FIG. 2, column 340 when projected on a screen can be used to communicate using a binary encoding the population sum signal for use with the neurons in the next layer of the model. Although FIG. 3 shows the intensity differences in gray, colors (e.g., blue and red) with different intensities can be used to communicate this information. The color information can be used to communicate the sign (positive or negative) associated with a binary value. The receiving hardware (e.g., a camera with an ASIC processing board) and software can then parse the red and blue signals and provide them for calculation of a₀^{(l-1)}w_{0,1}^{(l)}+a₁^{(l-1)}w_{1,1}^{(l)}+a₂^{(l-1)}w_{2,1}^{(l)}+a₃^{(l-1)}w_{3,1}^{(l)}, which has been simplified through the projection overlay process to sum positive activations and negative activations.

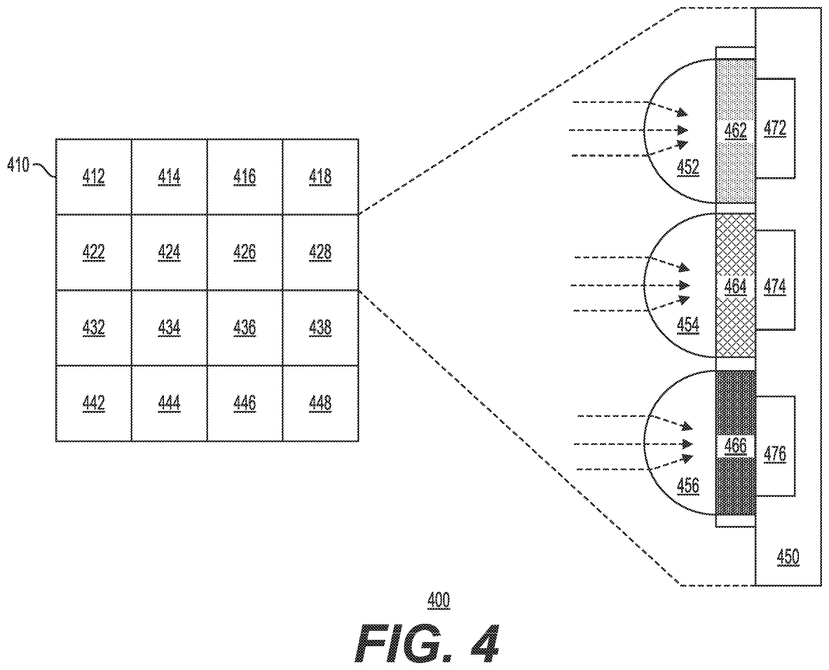

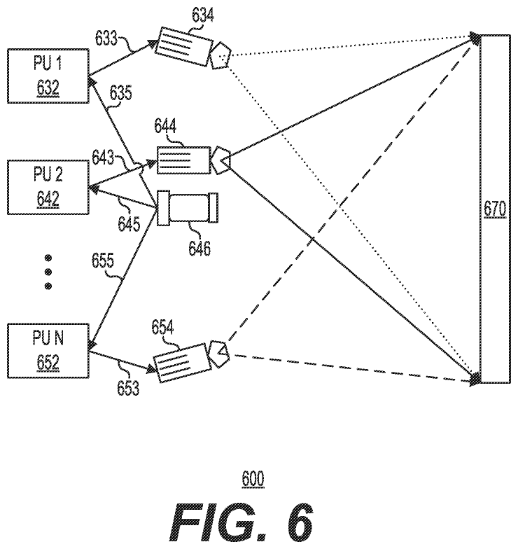

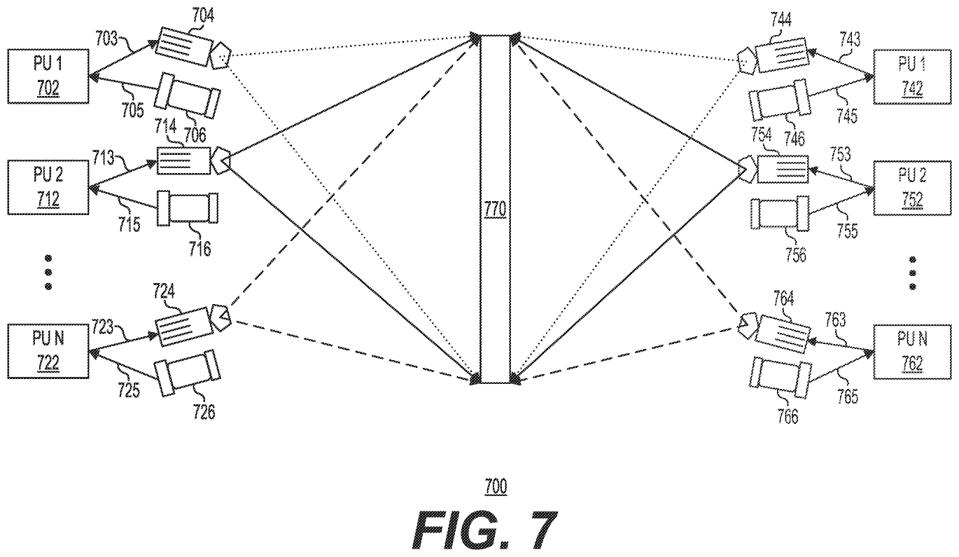

FIG. 4 shows example processing 400 of information communicated, for performing a collective operation, via electromagnetic radiation by an image sensor on a pixel-by-pixel basis. As explained earlier, intensity and color values associated with projected (or otherwise communicated) electromagnetic radiation can be used to communicate individual reference signals, population reference signals, and population sum signals for use with the neurons in the next layer of the model. As an example, FIG. 3 shows that a column (e.g., column 340 of FIG. 3) can include bitwise population sum signal values. Each item (e.g., a rectangle or a square) in the column includes both intensity and color information. In this example processing 400, one such square 410 can include multiple pixels (e.g., 16 pixels, which are labeled as 412, 414, 416, 418, 422, 424, 426, 428, 432, 434, 436, 438, 442, 444, 446, and 448 in FIG. 4). Each pixel (e.g., pixel 428) can be processed using a sensor 450. Sensor 450 corresponds to an electromagnetic radiation sensor (e.g., the cameras described earlier with respect to FIG. 1 and later with respect to FIGS. 6 and 7). Sensor 450 includes lenses 452, 454, and 456 to focus the light onto image sensing elements 472, 474, and 476. The focused light rays also can travel through color filters. In this example, the color filters include a red color filter 462, a green color filter 464, and a blue color filter 466. Each image sensing element generates a signal proportional to the intensity of the impinging electromagnetic radiation for the specific color if visible light is used.

Alternatively, the filters can simply be configured to filter electromagnetic radiation corresponding to specific wavelengths. As an example, a filter could be set to filter (allow passage of) electromagnetic radiation between 600 nanometers to 610 nanometers and/or other such ranges of wavelengths. The signals captured by the image sensing elements can be further processed before being passed on to a respective processing unit (e.g., the processing units coupled to the cameras shown in FIG. 1) associated with the neurons in a layer. Although FIG. 4 shows a certain number and arrangement of pixels, additional or fewer pixels may be used. In addition, any number and type of lenses, filters, and image sensing elements may be deployed depending on the wavelengths or other properties of the electromagnetic radiation being processed. In sum, the property of the electromagnetic radiation may comprise luminous intensity, color, wavelength, a polarization-related property, a fluorescence-related property, a phosphorescence-related property, a storage-related property, a reflection-related property, or a combination of one or more of the aforementioned properties.

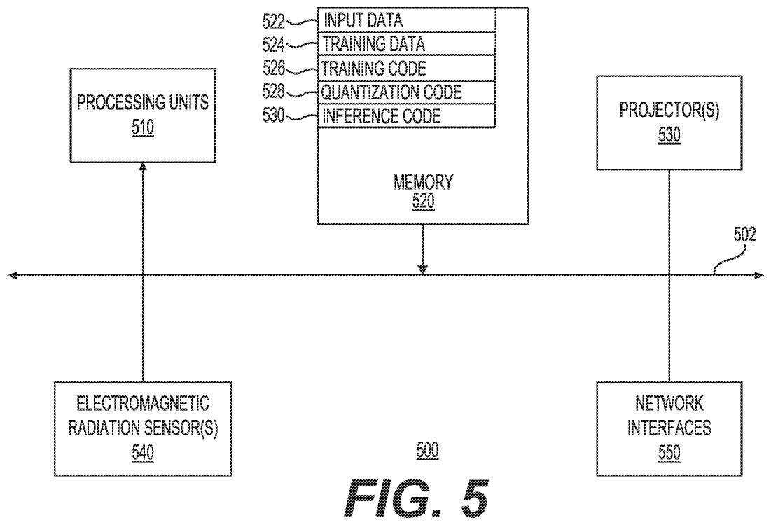

FIG. 5 shows a system 500 for processing an artificial intelligence (AI) model in accordance with one example. System 500 may include processing units 510 (e.g., similar to the processing units described earlier with respect to FIG. 1) and a memory 520. System 500 may further include projector(s) 530 (e.g., similar to the projectors described earlier with respect to FIG. 1), electromagnetic radiation sensor(s) 540 (e.g., similar to the cameras described earlier with respect to FIG. 1), and network interfaces 550 interconnected via bus system 502. Memory 520 may include input data 522, training data 524, training code 526, quantization (Q) code 528, and inference code 530. Input data 522 may comprise data corresponding to images, words, sentences, videos, or other types of information that can be classified or otherwise processed using AI model. Memory 520 may further include training data 524 that may include weights and biases obtained by training the AI model. Memory 520 may further include training code 526 comprising instructions configured to train an AI model or a neural network, such as ResNet-50. Training code 526 may use the weights and biases obtained by training the neural network.

Quantization code 528 may include instructions configured to scale and quantize input data 522 or training data 524. In one example, scaling may include multiplying the data that is in a higher precision format (e.g., FP32 or FP16) by a scaling factor. Quantizing may include converting the scaled values of the data from the higher precision format to a lower precision format (e.g., an integer or a block floating point format). As explained earlier with respect to FIG. 3, the use of lower precision format data allows the use of lower bandwidth binary encoding and summation.

With continued reference to FIG. 5, memory 520 may further include inference code 530 comprising instructions to perform inference using a trained AI model or a neural network. Although FIG. 5 shows a certain number of components of system 500 arranged in a certain way, additional or fewer components arranged differently may also be used. As an example, processing units 510 may include local memory blocks, which may be cache memory, block RAM (BRAM), or other type of local memory blocks. In addition, although memory 520 shows certain blocks of code, the functionality provided by this code may be combined or distributed. In addition, the various blocks of code may be stored in non-transitory computer-readable media, such as non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory, such as, DRAM, SRAM, a cache, or other such media.

FIG. 6 shows another example system 600 (an alternative to system 130 of FIG. 1) for performing a collective operation as part of the system environment 100 of FIG. 1. Unlike system 130 of FIG. 1, which uses a set of distributed cameras, system 600 uses only one camera. System 600 includes several processing units (e.g. processing units PU 1 632, PU 2 642, and PU N 652). Each of the processing units can be a graphics processing unit (GPU). As explained earlier, the processing units can be implemented using other hardware options, as well. As an example, a processing unit may be implemented as one or more computer processing units (CPUs), field programmable gate arrays (FPGAs), application specific integrated circuits (ASICs), erasable and/or complex programmable logic devices (PLDs), programmable array logic (PAL) devices, or generic array logic (GAL) devices. In this example, each of the processing units is further coupled to a projector and a shared camera. As an example, PU 1 632 is coupled via link 633 to a projector 634 and is also coupled via link 635 to a shared camera 646. PU 2 642 is coupled via link 643 to a projector 644 and is also coupled via link 645 to the shared camera 646. PU N 652 is coupled via link 653 to a projector 654 and is also coupled via link 655 to the shared camera 646. Each of links 633, 643, and 653 may be implemented as a display port link. Other high-speed links for connecting processing units to projectors may also be used. Link 645 may be implemented as a peripherals component express (PCIe) link. Oher high-speed links for connecting processing units to cameras may also be used. Each projector is configured to project information communicated via electromagnetic radiation onto the surface of screen 670 or onto the surface of a wall.

FIG. 7 shows another example system 700 for performing a collective operation as part of the system environment of FIG. 1. System 700 includes two sets of N processing units one set (e.g. N processing units PU 1 702, PU 2 712, and PU N 722) of which is on one side of a shared two-way mirror or screen 770 and the other set (e.g. N processing units PU 1 742, PU 2 752, and PU N 762) is on the other side of the shared two-way mirror or screen 770. Each of the processing units can be a graphics processing unit (GPU). As explained earlier, the processing units can be implemented using other hardware options, as well. As an example, a processing unit may be implemented as one or more computer processing units (CPUs), field programmable gate arrays (FPGAs), application specific integrated circuits (ASICs), erasable and/or complex programmable logic devices (PLDs), programmable array logic (PAL) devices, or generic array logic (GAL) devices.

In this example, each of the processing units is further coupled to a projector and a camera. As an example, PU 1 702 is coupled via link 703 to projector 704 and is also coupled via link 705 to camera 706. PU 2 712 is coupled via link 713 to projector 714 and is also coupled via link 715 to camera 716. PU N 722 is coupled via link 723 to projector 724 and is also coupled via link 725 to camera 726. PU 1 742 is coupled via link 743 to projector 744 and is also coupled via link 745 to camera 746. PU 2 752 is coupled via link 753 to projector 754 and is also coupled via link 755 to camera 756. PU N 762 is coupled via link 763 to projector 764 and is also coupled via link 765 to camera 766. Each of links 703, 713, 723, 743, 753, and 763 may be implemented as a display port link. Other high-speed links for connecting processing units to projectors may also be used. Each of links 705, 715, 725, 745, 755, and 765 may be implemented as a peripherals component express (PCIe) link. Other high-speed links for connecting processing units to cameras may also be used. Each projector is configured to project information communicated via electromagnetic radiation onto a surface of the shared two-way mirror or screen 770. In this example, the shared two-way mirror or screen allows projected signals on one side of the shared two-way mirror or screen to be communicated to the either side of the two-way mirror or screen.

This arrangement may allow better use of the shared surface for communicating using electromagnetic radiation the various signals described earlier. As an example, neurons associated with layers other than two layers (e.g., the first layer and the second layer) may be able to simultaneously use the shared surface for performing additional collective operations. Moreover, to enable better light control and security, the systems shown in FIGS. 1, 6, and 7 may be enclosed within a room (or another such structure) that prevents the ambient light from entering into the room. In addition, although FIGS. 1, 6, and 7 show the use of cameras and projectors, they could be replaced with other arrangements. Moreover, instead of the projectors, laser array grids or LED grids may be used for communicating the electromagnetic radiation.

Moreover, with respect to the systems shown in FIGS. 1, 6, and 7, the electromagnetic radiation may be communicated by projecting the signals on a fluorescent projection surface. A camera may acquire the signals for use with the second layer by capturing reflected electromagnetic radiation from the fluorescent projection surface. Polarized light and/or polarizing reflection conditions may also be used to increase the signal to noise ratio of the acquired signals. In addition, with respect to the systems shown in FIGS. 1, 6, and 7, the electromagnetic radiation may comprise polarized lights. Finally, with respect to the systems shown in FIGS. 1, 6, and 7, the electromagnetic radiation may be communicated by projecting the signals on a phosphorescent screen to enable memory and time-dependent neural processing similar to post-synaptic potentials.

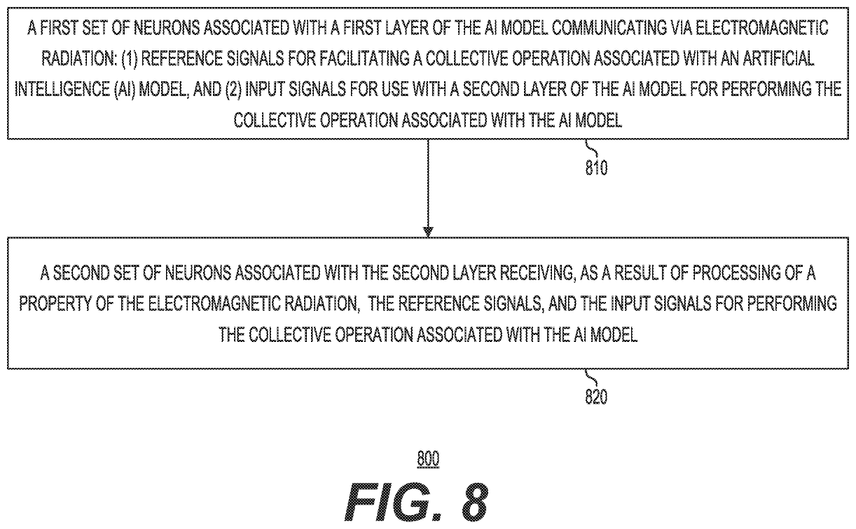

FIG. 8 shows a flow chart 800 of a method for processing an AI model in accordance with one example. System 130 shown in FIG. 1 (and similar systems described elsewhere) and system 500 of FIG. 5 may be used to perform steps associated with this method. Step 810 includes a first set of neurons associated with a first layer of the AI model communicating via electromagnetic radiation: (1) reference signals for facilitating a collective operation associated with the AI model, and (2) input signals for use with a second layer of the AI model for performing the collective operation associated with the AI model. The collective operation may be performed as part of inference or training. The first set of neurons (e.g., the neurons associated with layer L−1 of FIG. 2) may correspond to a first set of processing units and the second set of neurons (e.g., the neurons associated with layer L of FIG. 2) may correspond to a second set of processing units. The reference signals and input signals are further described with respect to FIG. 2 and FIG. 3. The input signals for use with the second layer may comprise binary-encoded population sum signals as described earlier with respect to FIG. 3.

Step 820 includes a second set of neurons associated with the second layer receiving, as a result of processing of a property of the electromagnetic radiation, the reference signals, and the input signals for performing the collective operation associated with the AI model. The property of the electromagnetic radiation comprises luminous intensity, color, wavelength, a polarization-related property, a fluorescence-related property, a phosphorescence-related property, a storage-related property, a reflection-related property, or a combination of one or more of the aforementioned properties. Advantageously, using the method described with respect to flow chart 800 allows one to perform a collective operation (e.g., AllReduce or summation) with potentially no wires for communication related to the collective operation among the processing units (e.g., GPUs). As a result, communication latencies are lowered. Although FIG. 8 describes a certain number of steps performed in a certain order, additional or fewer steps in a different order may be performed.

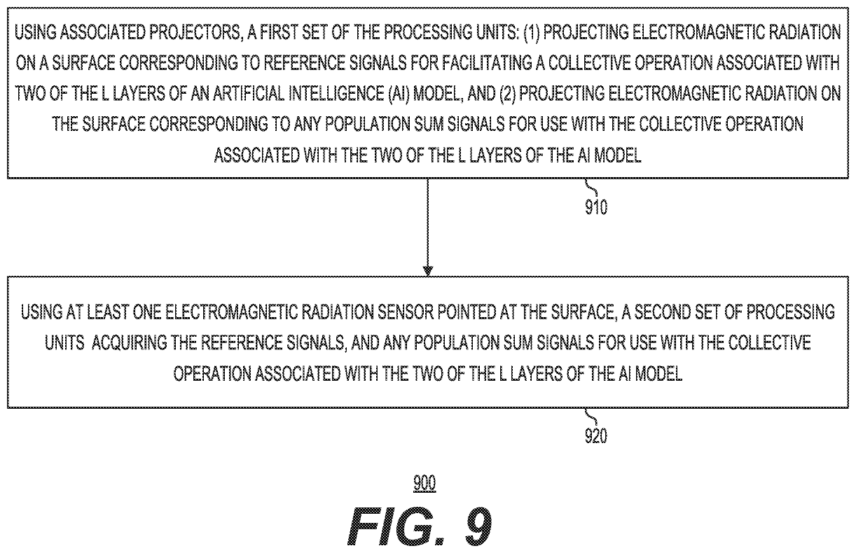

FIG. 9 shows a flow chart 900 of a method for processing an AI model comprising L layers in accordance with one example. System 130 shown in FIG. 1 (and similar systems described elsewhere) and system 500 of FIG. 5 may be used to perform steps associated with this method. Step 910 includes using associated projectors, a first set of the processing units: (1) projecting electromagnetic radiation on a surface corresponding to reference signals for facilitating a collective operation associated with two of the L layers of the AI model, and (2) projecting electromagnetic radiation on the surface corresponding to any population sum signals for use with the collective operation associated with the two of the L layers of the AI model. The collective operation may be performed as part of inference or training. The first set of neurons (e.g., the neurons associated with layer L−1 of FIG. 2) may correspond to a first set of processing units and the second set of neurons (e.g., the neurons associated with layer L of FIG. 2) may correspond to a second set of processing units. The reference signals and input signals are further described with respect to FIG. 2 and FIG. 3.

Step 920 includes using at least one camera pointed at the surface, a second set of processing units acquiring the reference signals, and any population sum signals for use with the collective operation associated with the two of the layers of the AI model. As explained earlier, such signals may be acquired using a camera or an optical detector. The population sum signals may comprise binary-encoded population sum signals as described earlier with respect to FIG. 3. Advantageously, using the method described with respect to flow chart 900 allows one to perform a collective operation (e.g., AllReduce or summation) with potentially no wires for communication related to the collective operation among the processing units (e.g., GPUs). As a result, as before, communication latencies are lowered. Although FIG. 9 describes a certain number of steps performed in a certain order, additional or fewer steps in a different order may be performed.

In conclusion, the present disclosure relates to [a method for processing an artificial intelligence (AI) model. The method may include a first set of neurons associated with a first layer of the AI model communicating via electromagnetic radiation: (1) reference signals for facilitating a collective operation associated with the AI model, and (2) input signals for use with a second layer of the AI model for performing the collective operation associated with the AI model. The method may further include a second set of neurons associated with the second layer receiving, as a result of processing of a property of the electromagnetic radiation, the reference signals, and the input signals for performing the collective operation associated with the AI model.

The property of the electromagnetic radiation may comprise luminous intensity, color, wavelength, a polarization-related property, a fluorescence-related property, a phosphorescence-related property, a storage-related property, a reflection-related property, or a combination of one or more of the aforementioned properties. The reference signals may comprise signals indicative of participation in the collective operation by neurons from among at least the first set of neurons or the second set of neurons.

The first set of neurons may correspond to a first set of processing units and the second set of neurons may correspond to a second set of processing units, and the reference signals may comprise individual reference signals for allowing normalization of the reference signals across at least one of the first set of processing units or the second set of processing units. The first set of neurons may correspond to a first set of processing units and the second set of neurons may correspond to a second set of processing units, and the reference signals may comprise population reference signals for tracking a population of at least one of the first set of processing units or the second set of processing units.

The input signals for use with the second layer may comprise binary-encoded population sum signals. The AI model may comprise L layers, where L is an integer greater than or equal to 2, where the first layer corresponds to layer L−1 and the second layer corresponds to layer L, and where the input signals are used for inference using the AI model. The AI model may comprise L layers, where L is an integer greater than or equal to 2, where the first layer corresponds to layer L and the second layer corresponds to layer L−1, and where the input signals are used for training the AI model.

In another example, the present disclosure relates to a method for processing an artificial intelligence (AI) model comprising L layers, where L is an integer greater than or equal to 2. The method may include using associated projectors, a first set of the processing units: (1) projecting electromagnetic radiation on a surface corresponding to reference signals for facilitating a collective operation associated with two of the L layers of the AI model, and (2) projecting electromagnetic radiation on the surface corresponding to any population sum signals for use with the collective operation associated with the two of the L layers of the AI model. The method may further include using at least one electromagnetic radiation sensor pointed at the surface, a second set of processing units acquiring the reference signals, and any population sum signals for use with the collective operation associated with the two of the layers of the AI model.

A first set of neurons may correspond to a first layer of the two of the layers of the AI model, a second set of neurons may correspond to a second layer of the two of the layers of the AI model, and the reference signals may comprise signals indicative of participation in the collective operation by neurons from among at least the first set of neurons or the second set of neurons. The first set of neurons may correspond to a first set of processing units and the second set of neurons correspond to a second set of processing units, and the reference signals may comprise individual reference signals for allowing normalization of the reference signals across at least one of the first set of processing units or the second set of processing units.

The first set of neurons may correspond to a first set of processing units and the second set of neurons may correspond to a second set of processing units, and the reference signals may comprise population reference signals for tracking a population of at least one of the first set of processing units or the second set of processing units. The first layer may correspond to layer L−1 and the second layer may correspond to layer L, and the population sum signals may be used for inference using the AI model. The first layer may correspond to layer L and the second layer may correspond to layer L−1, and the population signals may be used for training the AI model.

In a yet another example, the present disclosure relates to a system for processing an artificial intelligence (AI) model. The system may include a first sub-system to enable a first set of neurons associated with a first layer of the AI model to communicate via electromagnetic radiation: (1) reference signals for facilitating a collective operation associated with the AI model, and (2) input signals for use with a second layer of the AI model for performing the collective operation associated with the AI model. The system may further include a second sub-system to enable a second set of neurons associated with the second layer to receive, as a result of processing of a property of the electromagnetic radiation, the reference signals, and the input signals for performing the collective operation associated with the AI model.

The property of the electromagnetic radiation may comprise luminous intensity, color, wavelength, a polarization-related property, a fluorescence-related property, a phosphorescence-related property, a storage-related property, a reflection-related property, or a combination of one or more of the aforementioned properties. The electromagnetic radiation may be communicated by projecting the signals on a shared surface, where the first sub-system and the second sub-system is configured to allow neurons associated with layers other than the first layer and the second layer to enable simultaneous use of the shared surface for performing additional collective operations.

The electromagnetic radiation may be communicated by projecting the signals on a fluorescent projection surface, and a sensor may be configured to acquire the signals for use with the second layer by capturing reflected electromagnetic radiation from the fluorescent projection surface. The electromagnetic radiation may comprise polarized light. The electromagnetic radiation may be communicated by projecting the signals on a phosphorescent screen to enable time-dependent neural processing.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory, such as, DRAM, SRAM, a cache, or other such media. Non-transitory media is distinct from, but can be used in conjunction with, transmission media. Transmission media is used for transferring data and/or instruction to or from a machine. Exemplary transmission media include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A method for processing an artificial intelligence (AI) model, the method comprising:
a first set of neurons associated with a first layer of the AI model communicating via electromagnetic radiation: (1) reference signals for facilitating a collective operation associated with the AI model, and (2) input signals for use with a second layer of the AI model for performing the collective operation associated with the AI model; and
a second set of neurons associated with the second layer receiving, as a result of processing of a property of the electromagnetic radiation, the reference signals, and the input signals for performing the collective operation associated with the AI model.

2. The method of claim 1, wherein the property of the electromagnetic radiation comprises luminous intensity, color, wavelength, a polarization-related property, a fluorescence-related property, a phosphorescence-related property, a storage-related property, a reflection-related property, or a combination of one or more of the aforementioned properties.

3. The method of claim 1, wherein the reference signals comprise signals indicative of participation in the collective operation by neurons from among at least the first set of neurons or the second set of neurons.

4. The method of claim 1, wherein the first set of neurons correspond to a first set of processing units and the second set of neurons correspond to a second set of processing units, wherein the reference signals comprise individual reference signals for allowing normalization of the reference signals across at least one of the first set of processing units or the second set of processing units.

5. The method of claim 1, wherein the first set of neurons correspond to a first set of processing units and the second set of neurons correspond to a second set of processing units, and wherein the reference signals comprise population reference signals for tracking a population of at least one of the first set of processing units or the second set of processing units.

6. The method of claim 1, wherein the input signals for use with the second layer comprise binary-encoded population sum signals.

7. The method of claim 1, wherein the AI model comprises L layers, wherein L is an integer greater than or equal to 2, wherein the first layer corresponds to layer L−1 and the second layer corresponds to layer L, and wherein the input signals are used for inference using the AI model.

8. The method of claim 1, wherein the AI model comprises L layers, wherein L is an integer greater than or equal to 2, wherein the first layer corresponds to layer L and the second layer corresponds to layer L−1, and wherein the input signals are used for training the AI model.

9. A method for processing an artificial intelligence (AI) model comprising L layers, wherein L is an integer greater than or equal to 2, the method comprising:
using associated projectors, a first set of the processing units: (1) projecting electromagnetic radiation on a surface corresponding to reference signals for facilitating a collective operation associated with two of the L layers of the AI model, and (2) projecting electromagnetic radiation on the surface corresponding to any population sum signals for use with the collective operation associated with the two of the L layers of the AI model; and
using at least one electromagnetic radiation sensor pointed at the surface, a second set of processing units acquiring the reference signals, and any population sum signals for use with the collective operation associated with the two of the L layers of the AI model.

10. The method of claim 9, wherein a first set of neurons correspond to a first layer of the two of the layers of the AI model, wherein a second set of neurons correspond to a second layer of the two of the layers of the AI model, and wherein the reference signals comprise signals indicative of participation in the collective operation by neurons from among at least the first set of neurons or the second set of neurons.

11. The method of claim 10, wherein the first set of neurons correspond to a first set of processing units and the second set of neurons correspond to a second set of processing units, and wherein the reference signals comprise individual reference signals for allowing normalization of the reference signals across at least one of the first set of processing units or the second set of processing units.

12. The method of claim 10, wherein the first set of neurons correspond to a first set of processing units and the second set of neurons correspond to a second set of processing units, and wherein the reference signals comprise population reference signals for tracking a population of at least one of the first set of processing units or the second set of processing units.

13. The method of claim 10, wherein the first layer corresponds to layer L−1 and the second layer corresponds to layer L, and wherein the population sum signals are used for inference using the AI model.

14. The method of claim 10, wherein the first layer corresponds to layer L and the second layer corresponds to layer L−1, and wherein the population sum signals are used for training the AI model.

15. A system for processing an artificial intelligence (AI) model comprising:
a first sub-system to enable a first set of neurons associated with a first layer of the AI model to communicate via electromagnetic radiation: (1) reference signals for facilitating a collective operation associated with the AI model, and (2) input signals for use with a second layer of the AI model for performing the collective operation associated with the AI model; and
a second sub-system to enable a second set of neurons associated with the second layer to receive, as a result of processing of a property of the electromagnetic radiation, the reference signals, and the input signals for performing the collective operation associated with the AI model.

16. The system of claim 15, wherein the property of the electromagnetic radiation comprises luminous intensity, color, wavelength, a polarization-related property, a fluorescence-related property, a phosphorescence-related property, a storage-related property, a reflection-related property, or a combination of one or more of the aforementioned properties.

17. The system of claim 15, wherein the electromagnetic radiation is communicated by projecting the signals on a shared surface, and wherein the first sub-system and the second sub-system is configured to allow neurons associated with layers other than the first layer and the second layer to enable simultaneous use of the shared surface for performing additional collective operations.

18. The system of claim 15, wherein the electromagnetic radiation is communicated by projecting the signals on a fluorescent projection surface, and wherein a sensor is configured to acquire the signals for use with the second layer by capturing reflected electromagnetic radiation from the fluorescent projection surface.

19. The system of claim 15, wherein the electromagnetic radiation comprises polarized light.

20. The system of claim 15, wherein the electromagnetic radiation is communicated by projecting the signals on a phosphorescent screen to enable time-dependent neural processing.
